(19) United States
(12) Patent Application Publication
(10) Pub. No.: US 2026/0166782 A1
(43) Pub. Date: Jun. 18, 2026

(54) FORMING DRY FIBER COMPOSITE PREFORMS

(71) Applicant: The Boeing Company, Arlington, VA (US)

(72) Inventors: William L. Serencsits, Hollywood, SC (US); Jessica Offutt Fry, Charleston, SC (US)

(21) Appl. No.: 18/981,072

(22) Filed: Dec. 13, 2024

(51) Int. Cl. B29C 35/02; B29C 70/44; B29L 31/30

(52) U.S. Cl. CPC B29C 35/0272; B29C 70/443; B29L 2031/3076

(57) ABSTRACT

A method of forming a dry fiber stack, a carrier encapsulated composite, and a flexible consolidation and forming carrier are presented. The flexible consolidation and forming carrier comprises an integrated heating element arranged in a material support region, a flexible base material encompassing the integrated heating element, and a seal portion around a perimeter of the flexible consolidation and forming carrier.

### BACKGROUND INFORMATION

### 1. Field

The present disclosure relates generally to composite manufacturing and more specifically to forming dry fiber composite preforms.

### 2. Background

Heated preforming of a composite material from the initial flat sheet to the final, complex contour is a significant challenge. Heating the materials, either dry materials or prepreg, makes the material more easily formed. However, heating the materials increases the requirement for support of the material. Additionally, heating a non-consolidated material is made more difficult if the materials are not in intimate contact with each other.

Dry fiber preforms do not have much structural integrity. Dry fiber preforms are held together with polymer threads which have a low softening and melting temperature. Many forming processes impart significant forces to the fibers. When the materials are heated, the polymer threads soften and the forming processes tear the material apart instead of carefully forming into the desired preform shape. Some materials may tear during forming even if not heated.

Therefore, it would be desirable to have a method and apparatus that takes into account at least some of the issues discussed above, as well as other possible issues.

### SUMMARY

An embodiment of the present disclosure provides a flexible consolidation and forming carrier. The flexible consolidation and forming carrier comprises an integrated heating element arranged in a material support region; a flexible base material encompassing the integrated heating element; and a seal portion around a perimeter of the flexible consolidation and forming carrier.

Another embodiment of the present disclosure provides a carrier encapsulated composite. The carrier encapsulated composite comprises a first flexible consolidation and forming carrier with an integrated heating element in a material support region; a second flexible consolidation and forming carrier with an integrated heating element in a material support region; and a dry fiber stack between the first flexible consolidation and forming carrier and the second flexible consolidation and forming carrier and in contact with the material support region of the first flexible consolidation and forming carrier and the material support region of the second flexible consolidation and forming carrier.

Yet another embodiment of the present disclosure provides a method of forming a dry fiber stack. A dry fiber stack is placed between a material support region of a first flexible consolidation and forming carrier comprising an integrated heating element in the material support region. A second flexible consolidation and forming carrier comprising an integrated heating element in the material support region is positioned over the dry fiber stack. The second flexible consolidation and forming carrier is sealed to the first flexible consolidation and forming carrier to form a carrier encapsulated composite. A vacuum is applied to the dry fiber stack within the carrier encapsulated composite. The carrier encapsulated composite is shaped while the dry fiber stack is under vacuum.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of carrier encapsulated composite in accordance with an illustrative embodiment;

FIG. 4 is an illustration of a top view of a flexible consolidation and forming carrier with a dry fiber stack in accordance with an illustrative embodiment;

FIG. 5 is an illustration of a cross-sectional view of punch forming a carrier encapsulated composite in accordance with an illustrative embodiment;

FIG. 6 is an illustration of a cross-sectional view of roll forming a carrier encapsulated composite in accordance with an illustrative embodiment;

FIG. 7 is an illustration of graphs of vacuum compaction pressure and temperature of a carrier encapsulated composite during processing in accordance with an illustrative embodiment;

FIG. 8 is a flowchart of a method of processing a dry fiber stack using flexible consolidation and forming carriers in accordance with an illustrative embodiment;

FIG. 9 is a flowchart of a method of forming a dry fiber stack in accordance with an illustrative embodiment;

FIG. 10 is an illustration of an aircraft manufacturing and service method in a form of a block diagram in accordance with an illustrative embodiment; and

FIG. 11 is an illustration of an aircraft in a form of a block diagram in which an illustrative embodiment may be implemented.

### DETAILED DESCRIPTION

The illustrative examples recognize and take into account several considerations. The illustrative embodiments recognize and take into account that there are obstacles associated with handling and forming dry-fiber materials. The illustrative embodiments recognize and take into account that existing attempts to heat an un-supported composite material result in the materials falling apart. The illustrative embodiments recognize and take into account that existing procedures rely on large, bulky tools, which are expensive and consume considerable floor space.

The illustrative embodiments recognize and take into account that existing heating methods for dry fiber materials can be insufficient to reach consolidation temperature through thickness of preform due to the thickness of the preform. The illustrative embodiments recognize and take into account that dry fiber materials are inherently “bulky”. The illustrative embodiments recognize and take into account that dry fiber materials contain significant amounts of air which act as insulation.

The illustrative embodiments recognize and take into account that a combination of thickness and significant amounts of air can result in an inability to reach a desired temperature, and unacceptable temperature gradients through the preform. Due to the bulk (excess air) the material is hard to heat uniformly.

The illustrative embodiments recognize and take into account that for some existing processes, if sufficient temperatures are reached, material is unsupported. The illustrative embodiments recognize and take into account that without adequate support, the material tends to sag and fall apart.

The illustrative embodiments recognize and take into account that forming temperature results in the softening or melting of polymer stabilizing reinforcements (knit threads, veils), so tension applied to NCF material results in material falling apart.

The illustrative embodiments recognize and take into account that current roller forming methods for forming of dry fabric materials attempt to heat the material, which is held in tension by rollers. The illustrative embodiments recognize and take into account that infrared heating lamps in roller forming methods can be undesirably inefficient. The illustrative embodiments recognize and take into account that the tension of the rollers can tear the material apart.

The illustrative examples provide flexible consolidation and forming carriers. The illustrative examples impart tension to the heated carrier membrane using the rollers so the dry material is not damaged. The illustrative examples provide flexible consolidation and forming carriers with integrated heating elements. In the illustrative examples, the part is heated by conduction from the heating elements in the carrier membrane.

The illustrative examples describe a way to utilize a heated membrane carrier to pre-consolidate the plies, heat them, keep them at temperature through the forming process, and then maintain the shape after forming. The illustrative examples provide the flexible carrier material, which holds the dry material together and heats it with integral heating. The illustrative examples provide controlled application of vacuum, to provide for through thickness heating, and also relaxed vacuum to allow for fibers to slip during the forming phase of the process. The illustrative examples provide selective application of vacuum through the forming process to enable high quality forming of the preform.

The illustrative examples provide a vacuum tight carrier membrane to heat and support the dry fiber material through the forming process.

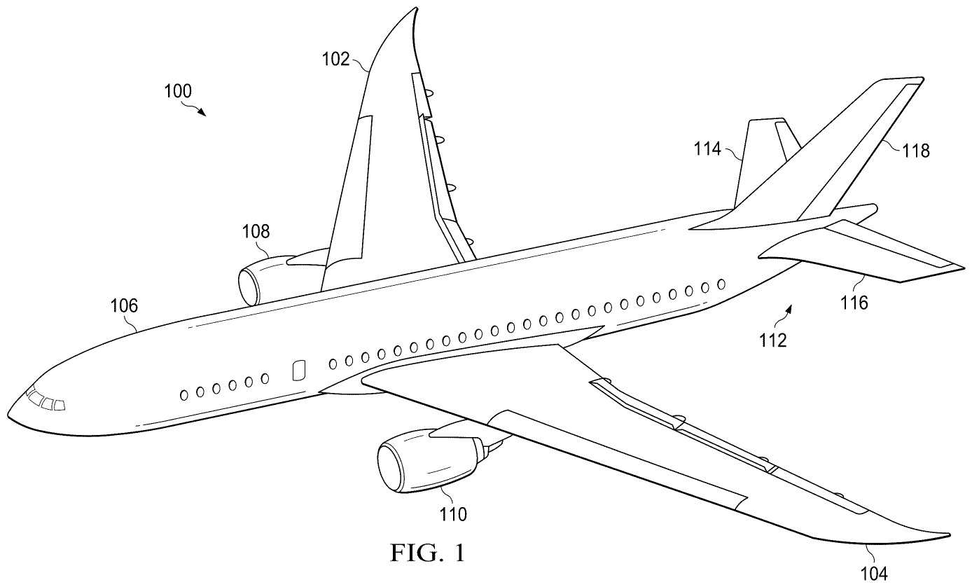

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite material parts manufactured using methods of the illustrative examples. In some illustrative examples, a portion of at least one of wing 102, wing 104, or body 106 can be a composite part formed using the illustrative examples.

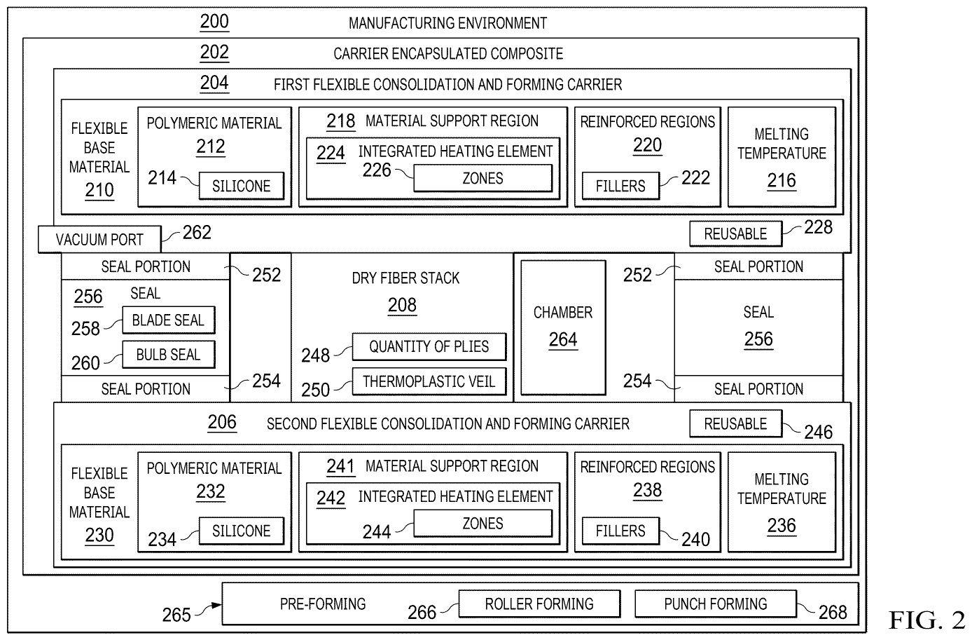

Turning now to FIG. 2, an illustration of a block diagram of a manufacturing environment is depicted in accordance with an illustrative embodiment. In manufacturing environment 200, dry fiber stack 208 is placed between first flexible consolidation and forming carrier 204 and second flexible consolidation and forming carrier 206 to form carrier encapsulated composite 202. Dry fiber stack 208 is consolidated and formed inside of carrier encapsulated composite 202. First flexible consolidation and forming carrier 204 and second flexible consolidation and forming carrier 206 heat dry fiber stack 208 using integrated heating element 224 and integrated heating element 242. In some illustrative examples, dry fiber stack 208 can be referred to as a non-crimp fabric.

Carrier encapsulated composite 202 comprises first flexible consolidation and forming carrier 204 with integrated heating element 224 in material support region 218, second flexible consolidation and forming carrier 206 with integrated heating element 242 in material support region 241, and dry fiber stack 208 between first flexible consolidation and forming carrier 204 and second flexible consolidation and forming carrier 206 and in contact with material support region 218 of first flexible consolidation and forming carrier 204 and material support region 241 of second flexible consolidation and forming carrier 206.

First flexible consolidation and forming carrier 204 is sealed to second flexible consolidation and forming carrier 206 by seal 256 comprising one of blade seal 258 or bulb seal 260. Vacuum port 262 is configured to provide vacuum communication through seal 256 to dry fiber stack 208. Integrated heating element 224 of first flexible consolidation and forming carrier 204 and integrated heating element 242 of second flexible consolidation and forming carrier 206 each comprise a respective plurality of independently controlled zones, zones 226 and zones 244.

First flexible consolidation and forming carrier 204 comprises integrated heating element 224 arranged in material support region 218, flexible base material 210 encompassing integrated heating element 224, and seal portion 252 around a perimeter of first flexible consolidation and forming carrier 204. First flexible consolidation and forming carrier 204 is configured to heat dry fiber stack 208 in contact with material support region 218. First flexible consolidation and forming carrier 204 is configured to heat dry fiber stack 208 using integrated heating element 224. Integrated heating element 224 takes any desirable form. Integrated heating element 224 is sufficiently flexible to move with flexible base material 210 in forming dry fiber stack 208. In some illustrative examples, integrated heating element 224 is arranged in any desirable orientation or arrangement. In some illustrative examples, integrated heating element 224 is arranged in a serpentine pattern. In some illustrative examples, integrated heating element 224 comprises a plurality of independently controlled zones, zones 226. A heater controller (not depicted) can be present to control different zones, zones 226 of integrated heating element 224 and zones 244 of integrated heating element 242. Thickness and power of integrated heating element 224 and integrated heating element 242 can be tailored based on materials and size of parts.

Flexible base material 210 comprises polymeric material 212. Flexible base material 210 comprises polymeric material 212 with melting temperature 216 higher than a forming temperature of dry fiber stack 208. Flexible base material 210 is sufficiently flexible to move with dry fiber stack 208 during forming of dry fiber stack 208. Flexible base material 210 is sufficiently flexible to undergo a forming process while maintaining temperature. In some illustrative examples, flexible base material 210 comprises silicone 214.

In some illustrative examples, flexible base material 210 comprises a single flexibility throughout first flexible consolidation and forming carrier 204. In some illustrative examples, reinforced regions 220 with fillers 222 are configured to change a flexibility within reinforced regions 220. In some illustrative examples, flexible base material 210 is chosen to become more flexible at forming temperature and rigid when cool to provide additional preform stability.

First flexible consolidation and forming carrier 204 is an integrally heated carrier material that is larger than the overall size of dry fiber stack 208 and seals against another flexible consolidation and forming carrier, such as second flexible consolidation and forming carrier 206. A heated carrier material mitigates use of external heaters. Additionally, conduction is superior to radiation for heating as conduction heating by integrated heating element 224 can be precisely controlled with TC feedback.

In some illustrative examples, seal portion 252 comprises integral sealing surfaces. Seal portion 252 is configured to interface with a seal portion of an additional flexible consolidation and forming carrier to seal dry fiber stack 208 within a chamber between first flexible consolidation and forming carrier 204 and the additional flexible consolidation and forming carrier. In this illustrative example, first flexible consolidation and forming carrier 204 is sealed to second flexible consolidation and forming carrier 206 to form chamber 264.

Vacuum port 262 is configured to provide vacuum communication through seal portion 252 to material support region 218. Vacuum port 262 is configured to provide vacuum communication through seal portion 252 to dry fiber stack 208 within chamber 264.

Dry fiber stack 208 comprises quantity of plies 248 with thermoplastic veil 250. Thermoplastic veil 250 is at least one of melted or softened by heating by integrated heating element 224 of first flexible consolidation and forming carrier 204.

Second flexible consolidation and forming carrier 206 comprises integrated heating element 242 arranged in material support region 241, flexible base material 230 encompassing integrated heating element 242, and seal portion 254 around a perimeter of second flexible consolidation and forming carrier 206. Second flexible consolidation and forming carrier 206 is configured to heat dry fiber stack 208 in contact with material support region 241. Second flexible consolidation and forming carrier 206 is configured to heat dry fiber stack 208 using integrated heating element 242. Integrated heating element 242 takes any desirable form. Integrated heating element 242 is sufficiently flexible to move with flexible base material 230 in forming dry fiber stack 208. In some illustrative examples, integrated heating element 242 is arranged in any desirable orientation or arrangement. In some illustrative examples, integrated heating element 242 is arranged in a serpentine pattern. In some illustrative examples, integrated heating element 242 comprises a plurality of independently controlled zones, zones 244.

Flexible base material 230 comprises polymeric material 232. Flexible base material 230 comprises polymeric material 232 with melting temperature 236 higher than a forming temperature of dry fiber stack 208. Flexible base material 230 is sufficiently flexible to move with dry fiber stack 208 during forming of dry fiber stack 208. In some illustrative examples, flexible base material 230 comprises silicone 234.

In some illustrative examples, flexible base material 230 comprises a single flexibility throughout second flexible consolidation and forming carrier 206. In some illustrative examples, reinforced regions 238 with fillers 240 are configured to change a flexibility within reinforced regions 238.

Seal portion 254 is configured to interface with seal portion 252 of first flexible consolidation and forming carrier 204 to seal dry fiber stack 208 within a chamber between second flexible consolidation and forming carrier 206 and first flexible consolidation and forming carrier 204. In this illustrative example, second flexible consolidation and forming carrier 206 is sealed to first flexible consolidation and forming carrier 204 to form chamber 264.

Seal portion 252 and seal portion 254 interface to form seal 256. In some illustrative examples, seal 256 is one of blade seal 258 or bulb seal 260. In some illustrative examples, seal portion 252 comprises a portion of at least one of blade seal 258 or bulb seal 260. In some illustrative examples, seal portion 254 comprises a portion of at least one of blade seal 258 or bulb seal 260.

To process dry fiber stack 208, heat from integrated heating element 224 and integrated heating element 242 is applied to dry fiber stack 208. Quantity of plies 248 is high enough that convective heating would not heat dry fiber stack 208 evenly. In some illustrative examples, quantity of plies 248 comprises twenty or more plies. In some illustrative examples, dry fiber stack 208 can be referred to as a full thickness part.

While heating dry fiber stack 208 within chamber 264 formed by first flexible consolidation and forming carrier 204 and second flexible consolidation and forming carrier 206, vacuum is applied and controlled through vacuum port 262. Application of vacuum compacts dry fiber stack 208, to improve through thickness heating and improve material stability.

During compaction of dry fiber stack 208, a full vacuum can be applied to dry fiber stack 208. During shaping and forming of dry fiber stack 208, vacuum is lessened to control stiffness and to prevent or reduce wrinkles. Lowering the vacuum enables shifting and sliding of plies in dry fiber stack 208 to prevent or reduce wrinkles. When dry fiber stack 208 has reached a final shape, vacuum is increased to full vacuum. A full vacuum is held until dry fiber stack 208 is cool enough for thermoplastic veil 250 to have cooled and retain final form shape.

Prior to compaction, dry fiber stack 208 is loaded onto one of first flexible consolidation and forming carrier 204 or second flexible consolidation and forming carrier 206 and first flexible consolidation and forming carrier 204 and second flexible consolidation and forming carrier 206 are sealed to form chamber 264.

Dry fiber stack 208 is compacted and heated within chamber 264. Carrier encapsulated composite 202 is sent through pre-forming 265 for dry fiber stack 208. Carrier encapsulated composite 202 is formed as a unit through at least one of roller forming 266, punch forming 268, vacuum forming, or any other desirable preforming operation.

After pre-forming 265 dry fiber stack 208, at least one of ambient cooling or active cooling with forced air convection is performed for a post forming cool down. In some illustrative examples, dry fiber stack 208 is removed from first flexible consolidation and forming carrier 204 or second flexible consolidation and forming carrier 206 afterwards. In some illustrative examples, dry fiber stack 208 is kept in place between first flexible consolidation and forming carrier 204 and second flexible consolidation and forming carrier 206 to remain rigid at room temperature and to assist with transportation of dry fiber stack 208.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, a series of rollers can be present in manufacturing environment 200 to perform roller forming 266. As another example, a punch and die can be present in manufacturing environment 200 to perform punch forming 268.

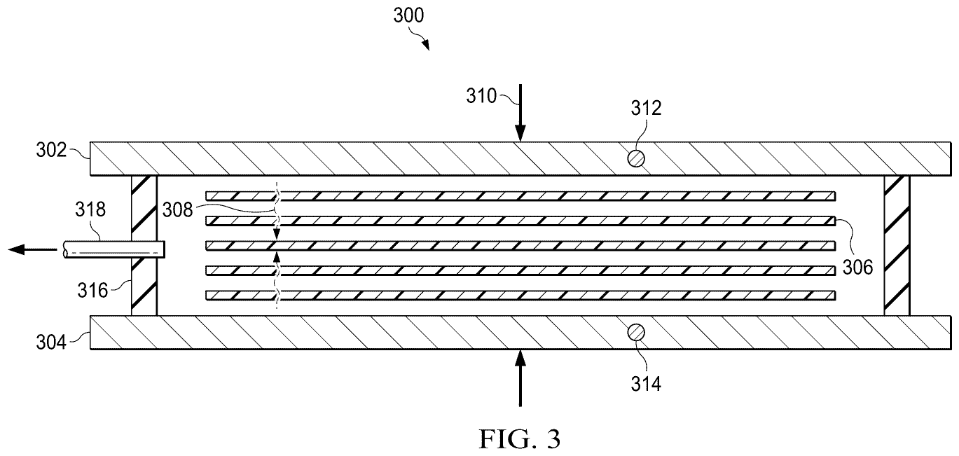

Turning now to FIG. 3, an illustration of a cross-sectional view of carrier encapsulated composite is depicted in accordance with an illustrative embodiment. Carrier encapsulated composite 300 can be used to compact and preform a composite structure of aircraft 100 of FIG. 1. Carrier encapsulated composite 300 can be a physical implementation of carrier encapsulated composite 202 of FIG. 2.

Carrier encapsulated composite 300 comprises first flexible consolidation and forming carrier 302 with an integrated heating element in a material support region, second flexible consolidation and forming carrier 304 with an integrated heating element in a material support region; and dry fiber stack 306 between first flexible consolidation and forming carrier 302 and second flexible consolidation and forming carrier 304. Dry fiber stack 306 is in contact with the material support region of first flexible consolidation and forming carrier 302 and the material support region of the second flexible consolidation and forming carrier 304.

First flexible consolidation and forming carrier 302 is sealed to second flexible consolidation and forming carrier 304 by seal 316 comprising one of a blade seal or a bulb seal. Vacuum port 318 is configured to provide vacuum communication through seal 316 to dry fiber stack 306.

Integrated heating elements in first flexible consolidation and forming carrier 302 and second flexible consolidation and forming carrier 304 provide heat flow 308 into the entire thickness of dry fiber stack 306. Compaction pressure 310 is applied to dry fiber stack 306 while dry fiber stack 306 is under vacuum through vacuum port 318.

Feedback thermocouple 312 in first flexible consolidation and forming carrier 302 is used to control heating by the integrated heating element in first flexible consolidation and forming carrier 302. Feedback thermocouple 314 in second flexible consolidation and forming carrier 304 is used to control heating by the integrated heating element in second flexible consolidation and forming carrier 304.

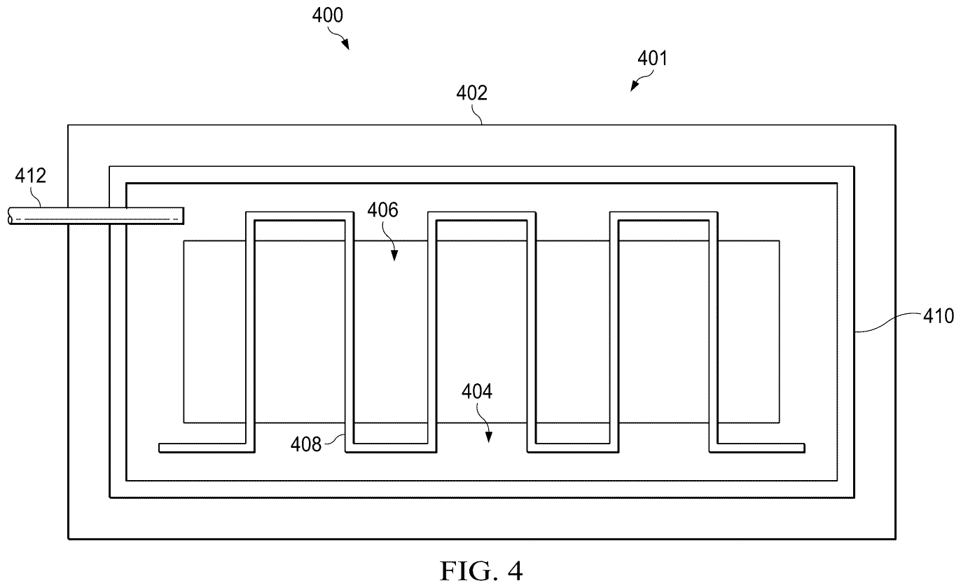

Turning now to FIG. 4, an illustration of a top view of a flexible consolidation and forming carrier with a dry fiber stack is depicted in accordance with an illustrative embodiment. View 400 is a top view of flexible consolidation and forming carrier 401 with dry fiber preform 406. Dry fiber preform 406 may also be referred to as a dry fiber stack. Flexible consolidation and forming carrier 401 can be used to form dry fiber preform 406 into a composite structure of aircraft 100 of FIG. 1. Flexible consolidation and forming carrier 401 can be a physical implementation of one of first flexible consolidation and forming carrier 204 or second flexible consolidation and forming carrier 206 of FIG. 2. In some illustrative examples, flexible consolidation and forming carrier 401 can be one of first flexible consolidation and forming carrier 302 or second flexible consolidation and forming carrier 304.

Flexible consolidation and forming carrier 401 comprises integrated heating element 408 arranged in material support region 404. Flexible base material 402 encompasses integrated heating element 408. Seal portion 410 is present around a perimeter of flexible consolidation and forming carrier 401. Vacuum port 412 extends through seal portion 410 to provide vacuum to dry fiber preform 406 within material support region 404.

In this illustrative example, although integrated heating element 408 is visible, in some illustrative examples, flexible base material 402 is opaque and integrated heating element 408 is not visible. Additionally, although dry fiber preform 406 is depicted in phantom, in practice, dry fiber preform 406 would be opaque and integrated heating element 408 would not be visible.

In this illustrative example, integrated heating element 408 has a serpentine design. In other non-depicted examples, an integrated heating element can have any desirable size and shape.

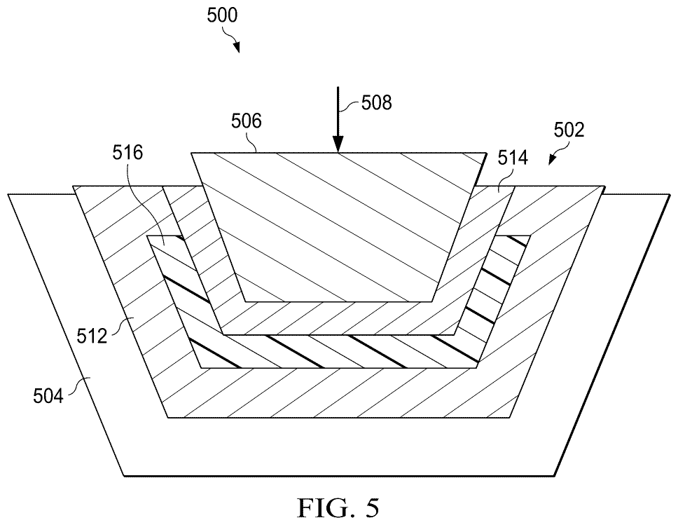

Turning now to FIG. 5, an illustration of a cross-sectional view of punch forming a carrier encapsulated composite is depicted in accordance with an illustrative embodiment. View 500 is a view of punch forming carrier encapsulated composite 502. In some illustrative examples, carrier encapsulated composite 502 can be used to form a component of aircraft 100 of FIG. 1. Carrier encapsulated composite 502 can be a physical implementation of carrier encapsulated composite 202 of FIG. 2. In some illustrative examples, carrier encapsulated composite 502 can be the same as carrier encapsulated composite 300 of FIG. 3. In some illustrative examples, carrier encapsulated composite 502 can comprise flexible consolidation and forming carrier 401 and dry fiber preform 406 of FIG. 4.

Carrier encapsulated composite 502 comprises dry fiber preform 516 sealed between first flexible consolidation and forming carrier 512 and second flexible consolidation and forming carrier 514. Carrier encapsulated composite 502 is formed by placing carrier encapsulated composite 502 onto die 504 and applying force 508 by punch 506. As punch 506 applies force 508, carrier encapsulated composite 502 is forced into die 504.

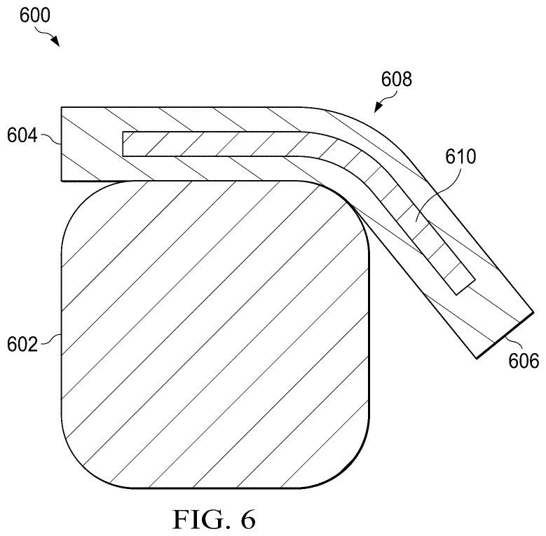

Turning now to FIG. 6, an illustration of a cross-sectional view of roll forming a carrier encapsulated composite is depicted in accordance with an illustrative embodiment. View 600 is a view of roller forming carrier encapsulated composite 604. In some illustrative examples, carrier encapsulated composite 604 can be used to form a component of aircraft 100 of FIG. 1. Carrier encapsulated composite 604 can be a physical implementation of carrier encapsulated composite 202 of FIG. 2. In some illustrative examples, carrier encapsulated composite 604 can be the same as carrier encapsulated composite 300 of FIG. 3. In some illustrative examples, carrier encapsulated composite 604 can comprise flexible consolidation and forming carrier 401 and dry fiber preform 406 of FIG. 4.

Carrier encapsulated composite 604 comprises dry fiber preform 610 sealed between first flexible consolidation and forming carrier 606 and second flexible consolidation and forming carrier 608. Carrier encapsulated composite 604 is formed by progressively applying force by roller 602.

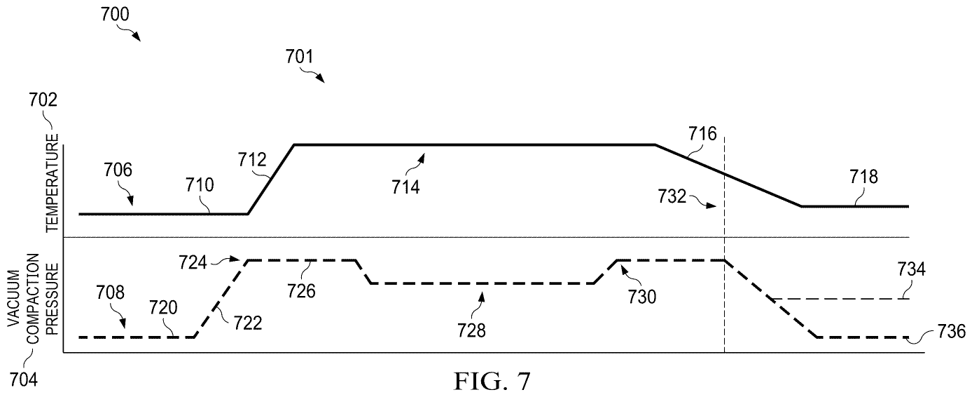

Turning now to FIG. 7, an illustration of graphs of vacuum compaction pressure and temperature of a carrier encapsulated composite during processing is depicted in accordance with an illustrative embodiment. View 700 is an illustration of temperature 702 and vacuum compaction pressure 704 during compaction and preforming cycle 701 of a dry fiber preform. In some illustrative examples, compaction and preforming cycle 701 can be performed to form a composite part of aircraft 100 of FIG. 1. In some illustrative examples, compaction and preforming cycle 701 can be performed on carrier encapsulated composite 202 of FIG. 2. In some illustrative examples, compaction and preforming cycle 701 can be performed on carrier encapsulated composite 300 of FIG. 3. In some illustrative examples, compaction and preforming cycle 701 can be performed on flexible consolidation and forming carrier 401 and dry fiber preform 406 of FIG. 4. In some illustrative examples, compaction and preforming cycle 701 can be performed on carrier encapsulated composite 502 of FIG. 5. In some illustrative examples, compaction and preforming cycle 701 can be performed on carrier encapsulated composite 604 of FIG. 6.

Ambient temperature 710 is maintained during compaction of the dry fiber preform. Prior to compaction, ambient pressure 720 is maintained. Vacuum ramp 722 occurs during compaction of the dry fiber preform to reach full compaction 724. In this illustrative example, full compaction 724 is reached prior to heating in temperature ramp 712. Beginning temperature ramp 712 after full compaction 724 reduces risk of overheating to outer plies of the dry fiber stack.

Active heating during forming process maintains preform temperature 714, so that preforming tooling can be unheated. Preform heat would be absorbed by colder tools.

Full vacuum 726 is maintained during temperature ramp 712 and initially during preform temperature 714. Reduced vacuum pressure 728 is applied during forming to allow plies in the dry fiber preform to slip.

Temperature ramp down 716 begins prior to vacuum venting 732 to set the dry fiber preform. In some illustrative examples, venting begins once preform temperature has cooled below a veil softening temperature.

Vacuum compaction pressure 704 returns to full vacuum 730 after the forming process for a final heat set of the dry fiber preform. Full vacuum 730 is maintained for full preform compaction and is held until the part has cooled to retain its final form shape. In some illustrative examples, vacuum compaction pressure 704 returns to ambient pressure 736 after the dry fiber preform has reached the final shape and has cooled sufficiently to retain the final shape. In some illustrative examples, partial vacuum pressure 734 can be maintained after forming to aid in transport of the dry fiber preform. If the dry fiber preform is being loaded into an infusion tool just in time, partial vacuum pressure 734 can be maintained to maintain a low preform moisture level.

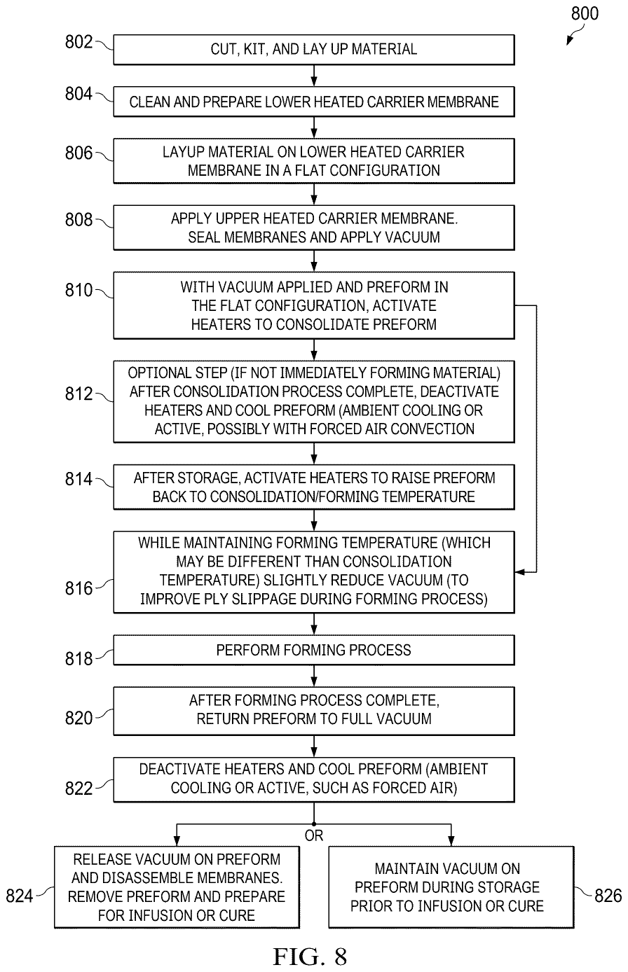

Turning now to FIG. 8, a flowchart of a method of processing a dry fiber stack using flexible consolidation and forming carriers is depicted in accordance with an illustrative embodiment. Method 800 can be performed to form a component of aircraft 100 of FIG. 1. Method 800 can be performed on dry fiber stack 208 in manufacturing environment 200. Method 800 can be performed on dry fiber stack 306 of FIG. 3. Method 800 can be performed on dry fiber preform 406 of FIG. 4. Method 800 can be performed on dry fiber preform 516 of FIG. 5. Method 800 can be performed on dry fiber preform 610 of FIG. 6. Method 800 can utilize the compaction and preforming cycle 701 of FIG. 7.

Method 800 cuts, kits, and lays up material (operation 802). The material comprises any desirable quantity of plies in the dry fiber preform.

Clean and prepare lower heated carrier membrane (operation 804). The lower heated carrier membrane comprises an integrated heating element in the area to receive the dry fiber preform. The lower heated carrier membrane further comprises a seal around the perimeter configured to seal to another heated carrier membrane.

Layup material on lower heated carrier membrane in a flat configuration (operation 806). In some illustrative examples, the material is laid up in a series of lay-up steps. In other illustrative examples, the material is laid up in a single placement step.

Apply upper heated carrier membrane. Seal membranes and apply vacuum (operation 808). In some illustrative examples, the seal comprises at least one of a blade seal or a bulb seal.

With vacuum applied and preform in the flat configuration, activate heaters to consolidate preform (operation 810). The heaters are configured to apply sufficient heat to reach a desired temperature throughout the preform.

An optional step can be provided if not immediately forming material. In some illustrative examples, after the consolidation process completes, heaters are deactivated and the preform is cooled. In the illustrative examples, cooling can be ambient or active, possibly with forced air convection. (operation 812).

After storage, activate heaters to raise preform back to consolidation/forming temperature (operation 814). At a forming temperature, the thermoplastic material is sufficiently flexible to be formed.

While maintaining forming temperature, which may be different than consolidation temperature, vacuum can be slightly reduced to improve ply slippage during forming process (operation 816). By reducing the vacuum, wrinkling can be reduced or eliminated during forming.

Method 800 performs forming process (operation 818). The forming process can be performed using any desirable process such as roller forming, punch forming, or any other desirable forming process.

After forming process complete, return preform to full vacuum (operation 820). The full vacuum can maintain rigidity of the preform during cooling.

Method 800 deactivates heaters and cools the preform. Cooling can be either ambient cooling or active, such as forced air. (operation 822).

In some illustrative examples, method 800 releases vacuum on preform and disassembles the membranes. Afterwards, the preform is removed and prepared for infusion or cure (operation 824).

In some illustrative examples, method 800 maintains vacuum on preform during storage prior to infusion or cure (operation 826). In some illustrative examples, resin infusion can be performed within the membranes.

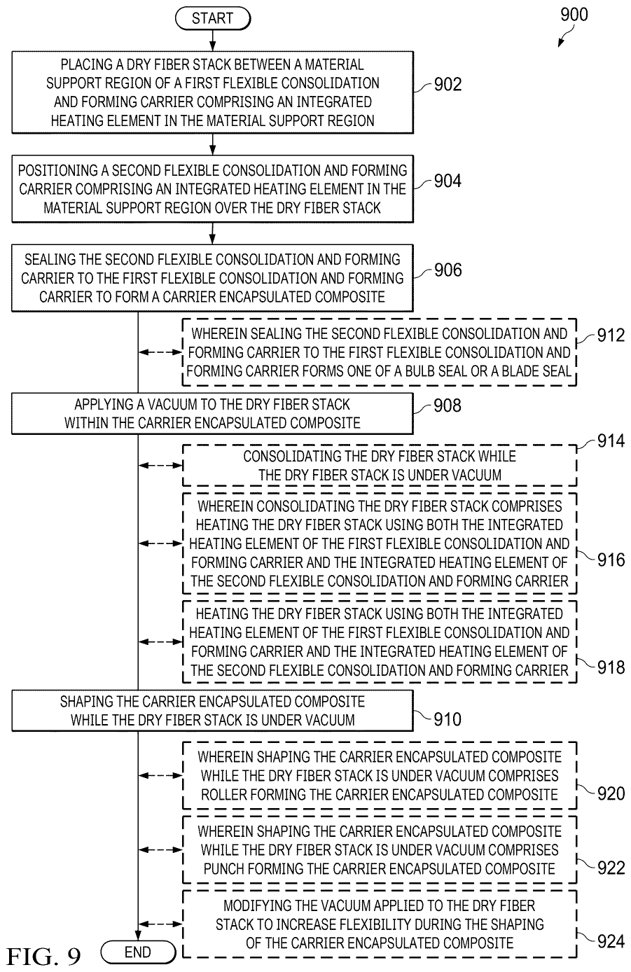

Turning now to FIG. 9, a flowchart of a method of forming a dry fiber stack is depicted in accordance with an illustrative embodiment. Method 900 can be performed to form a component of aircraft 100 of FIG. 1. Method 900 can be performed on dry fiber stack 208 in manufacturing environment 200. Method 900 can be performed on dry fiber stack 306 of FIG. 3. Method 900 can be performed on dry fiber preform 406 of FIG. 4. Method 900 can be performed on dry fiber preform 516 of FIG. 5. Method 900 can be performed on dry fiber preform 610 of FIG. 6. Method 900 can utilize the compaction and preforming cycle 701 of FIG. 7.

Method 900 places a dry fiber stack between onto a material support region of a first flexible consolidation and forming carrier comprising an integrated heating element in the material support region (operation 902). Method 900 positions a second flexible consolidation and forming carrier comprising an integrated heating element in the material support region over the dry fiber stack (operation 904). Method 900 seals the second flexible consolidation and forming carrier to the first flexible consolidation and forming carrier to form a carrier encapsulated composite (operation 906). Method 900 applies a vacuum to the dry fiber stack within the carrier encapsulated composite (operation 908). Method 900 shapes the carrier encapsulated composite while the dry fiber stack is under vacuum (operation 910). Afterwards, method 900 terminates.

In some illustrative examples, sealing the second flexible consolidation and forming carrier to the first flexible consolidation and forming carrier forms one of a bulb seal or a blade seal (operation 912).

In some illustrative examples, method 900 consolidates the dry fiber stack while the dry fiber stack is under vacuum (operation 914). In some illustrative examples, consolidating the dry fiber stack comprises heating the dry fiber stack using both the integrated heating element of the first flexible consolidation and forming carrier and the integrated heating element of the second flexible consolidation and forming carrier (operation 916). In some illustrative examples, method 900 heats the dry fiber stack using both the integrated heating element of the first flexible consolidation and forming carrier and the integrated heating element of the second flexible consolidation and forming carrier (operation 918).

In some illustrative examples, shaping the carrier encapsulated composite comprises any desirable pre-forming process. In some illustrative examples, shaping the carrier encapsulated composite while the dry fiber stack is under vacuum comprises roller forming the carrier encapsulated composite (operation 920). In some illustrative examples, shaping the carrier encapsulated composite while the dry fiber stack is under vacuum comprises punch forming the carrier encapsulated composite (operation 922).

In some illustrative examples, method 900 modifies the vacuum applied to the dry fiber stack to increase flexibility during the shaping of the carrier encapsulated composite (operation 924). In some illustrative examples vacuum is reduced during forming of the dry fiber stack so that plies of the dry fiber stack slip relative to each other during forming.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 912 through operation 924 may be optional.

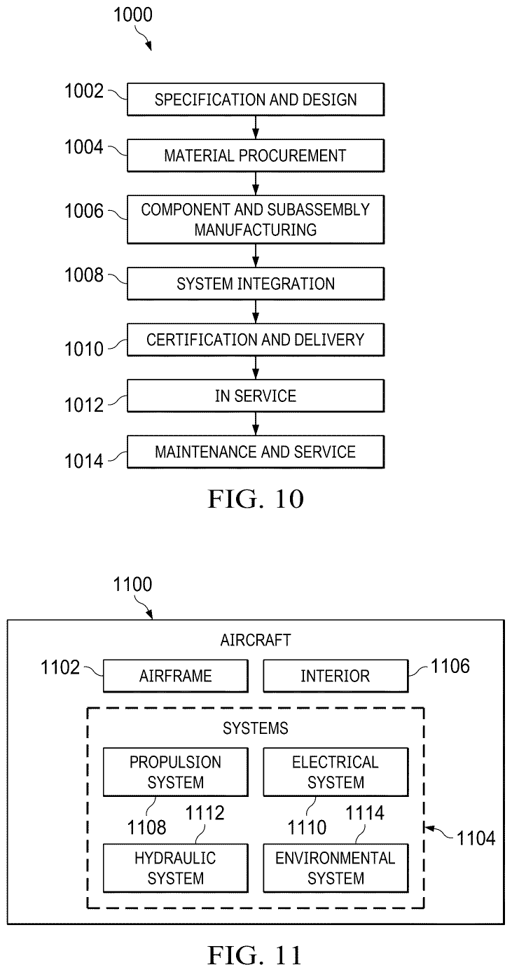

Illustrative embodiments of the present disclosure may be described in the context of aircraft manufacturing and service method 1000 as shown in FIG. 10 and aircraft 1100 as shown in FIG. 11. Turning first to FIG. 10, an illustration of an aircraft manufacturing and service method in a form of a block diagram is depicted in accordance with an illustrative embodiment. During pre-production, aircraft manufacturing and service method 1000 may include specification and design 1002 of aircraft 1100 in FIG. 11 and material procurement 1004.

During production, component and subassembly manufacturing 1006 and system integration 1008 of aircraft 1100 takes place. Thereafter, aircraft 1100 may go through certification and delivery 1010 in order to be placed in service 1012. While in service 1012 by a customer, aircraft 1100 is scheduled for routine maintenance and service 1014, which may include modification, reconfiguration, refurbishment, or other maintenance and service.

Each of the processes of aircraft manufacturing and service method 1000 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of an aircraft in a form of a block diagram is depicted in which an illustrative embodiment may be implemented. In this example, aircraft 1100 is produced by aircraft manufacturing and service method 1000 of FIG. 10 and may include airframe 1102 with plurality of systems 1104 and interior 1106. Examples of systems 1104 include one or more of propulsion system 1108, electrical system 1110, hydraulic system 1112, and environmental system 1114. Any number of other systems may be included.

Apparatuses and methods embodied herein may be employed during at least one of the stages of aircraft manufacturing and service method 1000. One or more illustrative embodiments may be manufactured or used during at least one of component and subassembly manufacturing 1006, system integration 1008, in service 1012, or maintenance and service 1014 of FIG. 10.

Some materials exist which are rigid at room temperature, but flexible when heated. If the carrier material was such a material, it would be flexible during the heating process but then remain rigid once cooled, assisting with the handling and transportation of the formed dry fiber composite part after the forming process was complete.

The illustrative examples can be used for the preforming of long, thin dry fiber composite shapes such as stringers, spars, or other L or hat shaped stiffeners, to be used in resin-infused structures for structural reinforcement.

Resin infusion provides increased fabrication rates and reduced facilities costs. The illustrative examples aid in the fabrication/forming of stiffeners to support the development of large-scale resin infused composite fabrication.

The illustrative examples provide a process for handling and supporting dry-fiber materials throughout forming. The process includes a pair of flexible carrier membranes, each having an integrate heating elements. The dry-fiber material is prepared and laid-up on a lower membrane, in a flat configuration.

An upper membrane placed over the material and lower membrane, with both membranes extending past the dry-fiber material and configured to seal against one another. Vacuum is applied between the membranes and the heaters are activated for consolidating the material, and vacuum is controlled to maintain rigidity and support while allowing plies to slip during forming process. The heaters can be adjusted for providing a desired temperature throughout the process.

The illustrative examples address obstacles associated with handling and forming dry-fiber materials. The preform material is sandwiched between a pair of flexible carrier membranes having integral heaters. With the dry fiber material disposed between the flexible carrier membranes, vacuum is initiated to compact the dry fiber material and hold the sandwich rigid. The heaters are engaged to maintain a desired temperature throughout the process.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A flexible consolidation and forming carrier comprising:
an integrated heating element arranged in a material support region;
a flexible base material encompassing the integrated heating element; and
a seal portion around a perimeter of the flexible consolidation and forming carrier.

2. The flexible consolidation and forming carrier of claim 1, wherein the seal portion comprises at least one of a blade seal or a bulb seal.

3. The flexible consolidation and forming carrier of claim 1, wherein the integrated heating element is arranged in a serpentine pattern.

4. The flexible consolidation and forming carrier of claim 1, wherein the flexible base material comprises a polymeric material with a melting temperature higher than a forming temperature of a dry fiber stack.

5. The flexible consolidation and forming carrier of claim 1, wherein the flexible base material comprises silicone.

6. The flexible consolidation and forming carrier of claim 1, wherein the flexible base material comprises reinforced regions with fillers configured to change a flexibility within the reinforced regions.

7. The flexible consolidation and forming carrier of claim 1 further comprising:
a vacuum port configured to provide vacuum communication through the seal portion to the material support region.

8. The flexible consolidation and forming carrier of claim 1, wherein the integrated heating element comprises a plurality of independently controlled zones.

9. A carrier encapsulated composite comprising:
a first flexible consolidation and forming carrier with an integrated heating element in a material support region;
a second flexible consolidation and forming carrier with an integrated heating element in a material support region; and
a dry fiber stack between the first flexible consolidation and forming carrier and the second flexible consolidation and forming carrier and in contact with the material support region of the first flexible consolidation and forming carrier and the material support region of the second flexible consolidation and forming carrier.

10. The carrier encapsulated composite of claim 9, wherein the first flexible consolidation and forming carrier is sealed to the second flexible consolidation and forming carrier by a seal comprising one of a blade seal or a bulb seal.

11. The carrier encapsulated composite of claim 10 further comprising:
a vacuum port configured to provide vacuum communication through the seal to the dry fiber stack.

12. The carrier encapsulated composite of claim 9, wherein the integrated heating element of the first flexible consolidation and forming carrier and the integrated heating element of the second flexible consolidation and forming carrier each comprise a respective plurality of independently controlled zones.

13. A method of forming a dry fiber stack comprising:
placing a dry fiber stack between a material support region of a first flexible consolidation and forming carrier comprising an integrated heating element in the material support region;
positioning a second flexible consolidation and forming carrier comprising an integrated heating element in the material support region over the dry fiber stack;
sealing the second flexible consolidation and forming carrier to the first flexible consolidation and forming carrier to form a carrier encapsulated composite;
applying a vacuum to the dry fiber stack within the carrier encapsulated composite; and
shaping the carrier encapsulated composite while the dry fiber stack is under vacuum.

14. The method of claim 13 further comprising:
consolidating the dry fiber stack while the dry fiber stack is under vacuum.

15. The method of claim 14, wherein consolidating the dry fiber stack comprises heating the dry fiber stack using both the integrated heating element of the first flexible consolidation and forming carrier and the integrated heating element of the second flexible consolidation and forming carrier.

16. The method of claim 13, wherein shaping the carrier encapsulated composite while the dry fiber stack is under vacuum comprises roller forming the carrier encapsulated composite.

17. The method of claim 13, wherein shaping the carrier encapsulated composite while the dry fiber stack is under vacuum comprises punch forming the carrier encapsulated composite.

18. The method of claim 13, wherein sealing the second flexible consolidation and forming carrier to the first flexible consolidation and forming carrier forms one of a bulb seal or a blade seal.

19. The method of claim 13 further comprising:
modifying the vacuum applied to the dry fiber stack to increase flexibility during the shaping of the carrier encapsulated composite.

20. The method of claim 13 further comprising:
heating the dry fiber stack using both the integrated heating element of the first flexible consolidation and forming carrier and the integrated heating element of the second flexible consolidation and forming carrier.
